(19) United States
(12) Patent Application Publication
(10) Pub. No.: US 2008/0169362 A1
(43) Pub. Date: Jul. 17, 2008

(54) Flow way diverter device

(76) Inventors: Henry Mang Hoi Kwan, Hong Kong (CN); Mang Loi Shang, Hong Kong (CN)

Correspondence Address: Raymond Y. Chan, Suite 128, 108 N. Ynez Avenue, Monterey Park, CA, 91754, US

(21) Appl. No.: 11/977,208

(22) Filed: Oct. 22, 2007

(30) Foreign Application Priority Data
Jan. 17, 2007 (CN) 200720118108.6

(51) Int. Cl. B05B 9/03

(52) U.S. Cl. 239/442

(57) ABSTRACT

A flow way diverter device includes a water flow divider and a supporting frame. The water flow has a water inlet, and first and second outlets for operatively coupling with a stationary showerhead and a handheld showerhead respectively, and a switch selectively switching water flowing from the water inlet to one of the first and second outlets. The supporting frame is rotatably coupling with the water flow divider for supporting the handheld showerhead to selectively adjust an inclined position of the handheld showerhead with respect to the water flow divider. Therefore, the stationary showerhead and the handheld showerhead are connected to the water source and are supported on the wall without pre-drilling a mounting hole on the wall.

### BACKGROUND OF THE PRESENT INVENTION

1. Field of Invention

The present invention relates to a fluid flow device, and more particularly to a flow way diverter device, wherein the handheld showerhead is coupled with the stationary showerhead via a height-adjustment frame to form the showerhead assembly as a shower combo set that the showerhead assembly the installation thereof does not require any mounting hole pre-drilling on the wall to minimize the installing parts and to simplify the installation operation of the showerhead assembly.

2. Description of Related Arts

As the living standards sharply improved, people have great demands on the high quality bathroom equipment. People not only require a good quality design for bathroom apparatus but also need such bathroom apparatus to be easily installed and operated. A conventional bathroom apparatus, such as a shower apparatus, comprises a showerhead being either immovably fixed on a shower arm from the wall or directly to the wall as a stationary showerhead, or adjustably mounted on the wall as a handheld showerhead. The bathroom apparatus further comprises a flow way diverter and a water temperature controller controlling the amount of water from the hot water source and the cold water source to the showerhead. Accordingly, the handheld showerhead generally held by a supporting frame being affixed either to a water pipe or on the wall, an adjustable frame movably mounted to the supporting frame to adjustably support the showerhead so as to selectively adjust a height of the showerhead. However, the user must drill a plurality of screw holes on the wall in order to affix the supporting frame. In addition, the bathroom apparatus contains lots of mounting tools, such as connecting rings and screws, in order to mount the bathroom apparatus on the wall. Since the wall surface is covered by either mosaic tile or glass tile, the tile may be easily to be cracked when the user tries to drill the hole on the wall. Therefore, an improved shower apparatus should be developed to meet the demands of the user.

### SUMMARY OF THE PRESENT INVENTION

A main object of the present invention is to provide a flow way diverter device which does not require any hole pre-drilling on the wall in order to mount the flow way diverter device on the wall so as to minimize the installing parts and to simplify the installation operation especially when the wall surface is covered by mosaic tile or glass tile. Accordingly, the traditional device requires a hole predrilled on the wall which will damage the wall structure and will complicate the installation operation of the device. In other words, the handheld showerhead is coupled with the stationary showerhead via a height-adjustment frame to form the showerhead assembly as a shower combo set that the showerhead assembly the installation thereof does not require any mounting hole pre-drilling on the wall to minimize the installing parts and to simplify the installation operation of the showerhead assembly. Therefore, the device of the present invention let the user to enjoy the shower through the handheld showerhead and the stationary showerhead.

Accordingly, the present invention provides a flow way diverter device comprising a water flow divider having a sidewall coupling with a supporting frame. Accordingly, the supporting frame is a showerhead mount for mounting to a handheld showerhead. Alternatively, the supporting frame is a height-adjustment for mounting the handheld showerhead.

According to the preferred embodiment, the water flow divider is coupled with the supporting frame via a rotatable joint. The rotatable joint is mounted between the sidewall of the water flow divider and is movably coupled with an end of the supporting frame such that the supporting frame is adapted to rotatably move with respect to the water flow divider.

According to the preferred embodiment, the water flow divider is coupled with the height-adjustment frame. A mount is slidably mounted to the height-adjustment frame to support the handheld showerhead such that the height-adjustment frame allows the handheld showerhead to be selectively adjusted the position along the height-adjustment frame.

According to the preferred embodiment, the water flow divider is coupled with the height-adjustment frame via a rotatable joint. The rotatable joint is mounted between the sidewall of the water flow divider and is movably coupled with an end of the height-adjustment frame. A mount is slidably mounted to the height-adjustment frame to support the handheld showerhead such that the height-adjustment frame not only is adapted to rotatably move with respect to the water flow divider to selectively adjust the inclined-position of the handheld showerhead but also allows the handheld showerhead to be selectively adjusted the height-position along the height-adjustment frame.

Accordingly, the present invention provides the flow way diverter device to simplify the installation operation of the showerhead assembly and to minimize the necessary components for installation. The stationary showerhead and the handheld showerhead are adapted to mount to the flow way diverter device without requiring any mounting hole pre-drilling on the wall surface. In particularly, the stationary showerhead is affixed to the water flow device while the handheld showerhead is either rotatably mounted to the showerhead mount or adjustably mounted to the height-adjustment frame. The present invention is especially designed for mounting on the wall in which the mounting hole cannot be formed on the wall surface. In other words, when the wall surface is covered by the mosaic tile or glass tile, the present invention is adapted to mount on the wall surface without drilling any mounting hole thereon to damage the wall structure and tile as well. Therefore, the present invention is adapted to keep the aesthetic appearance of the bathroom.

### BRIEF DESCRIPTION OF THE DRAWINGS

FIG. 1 is a perspective view of a flow way diverter device according to a first preferred embodiment of the present invention.

FIG. 2 is an exploded perspective view of the flow way diverter device according to the above first preferred embodiment of the present invention.

FIG. 3 is an exploded sectional view of the flow way diverter device according to the above first preferred embodiment of the present invention.

FIG. 4 is a sectional view of the flow way diverter device according to the above first preferred embodiment of the present invention.

FIG. 5 illustrates the flow way diverter device being mounted on the wall according to the above first preferred embodiment of the present invention.

FIG. 6 is a perspective view of a flow way diverter device according to a second preferred embodiment of the present invention.

FIG. 7 illustrates the movement of the flow way diverter device according to the above second preferred embodiment of the present invention.

FIG. 8 is an exploded perspective view of the flow way diverter device according to the above second preferred embodiment of the present invention.

FIG. 9 is an exploded sectional view of the flow way diverter device according to the above second preferred embodiment of the present invention.

FIG. 10 is a sectional view of the flow way diverter device according to the above second preferred embodiment of the present invention.

FIG. 11 illustrates the flow way diverter device being mounted on the wall according to the above second preferred embodiment of the present invention.

### DETAILED DESCRIPTION OF THE PREFERRED EMBODIMENT

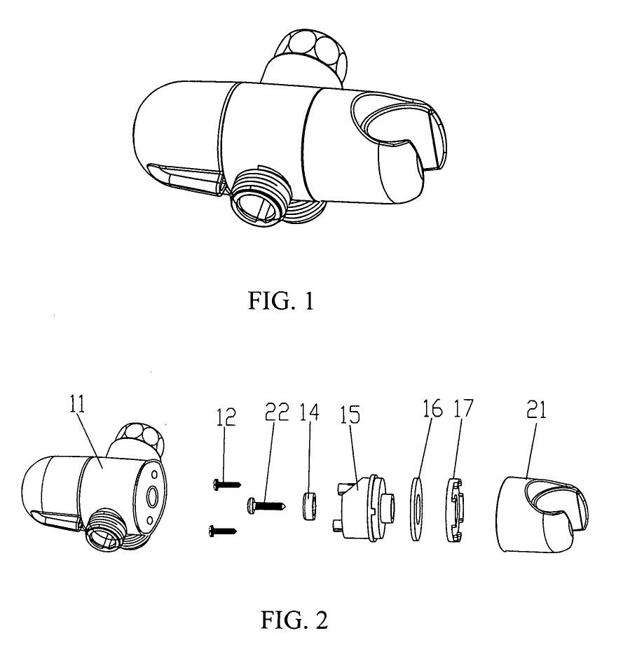

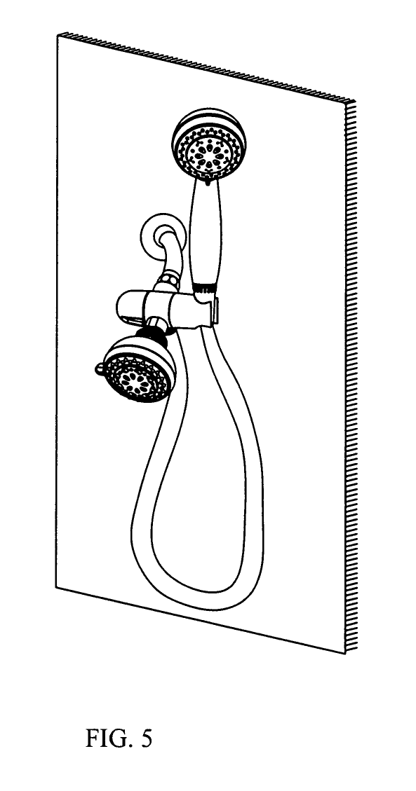

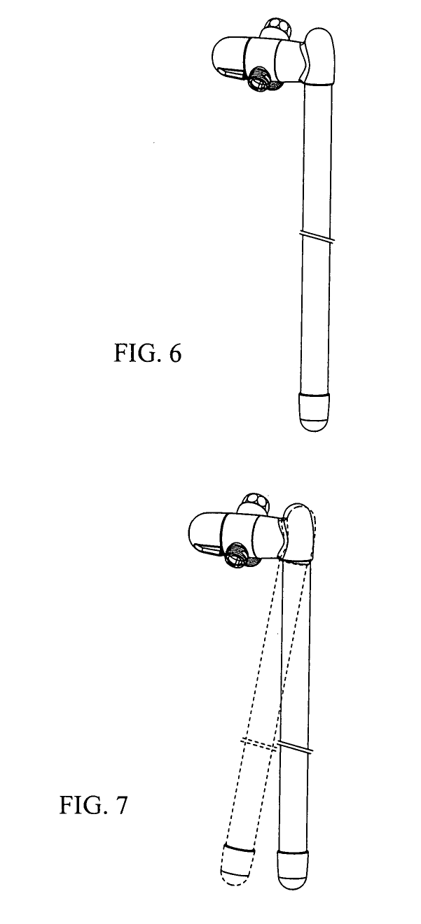

Referring to FIGS. 1 and 6 of the drawings, a flow way diverter device according to first and second embodiments of the present invention is illustrated, wherein the flow way diverter device comprises a water flow divider and a supporting frame. Accordingly, the water flow divider has a water inlet for communicatively coupling with a water source on the wall, first and second outlets for operatively coupling with a stationary showerhead and a handheld showerhead respectively, and a switch selectively switching water flowing from the water inlet to one of the first and second outlets. Accordingly, the supporting frame comprises a handheld showerhead support as shown in FIG. 1 or an adjustable frame as shown in FIG. 6. FIG. 1 illustrates the flow way diverter device of the first embodiment. FIG. 5 illustrates the flow way diverter device being mounted at the wall according to the first embodiment. FIG. 6 illustrates the flow way diverter device of the second embodiment. FIG. 11 illustrates the flow way diverter device being mounted at the wall according to the second embodiment.

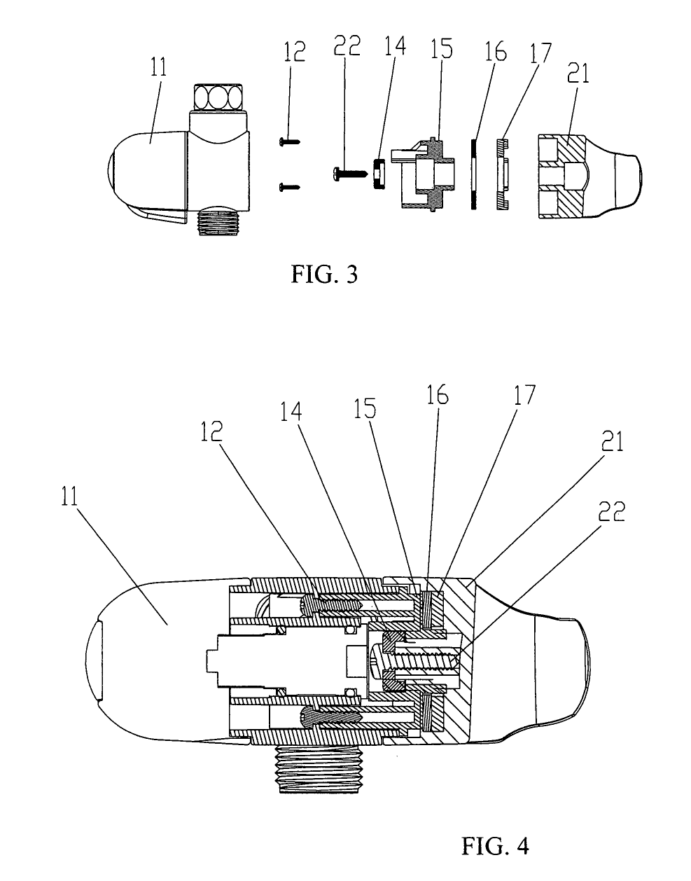

As shown in FIGS. 2, 3, and 4, the flow way diverter device comprises the water flow divider 11, two first screws 12, a second screw 22 having a size larger than a size of each of the first screws 12, a screw ring 14 for the second screw 22, a rotatable base 15, a gasket 16, a toothed gear 17, and a showerhead mount 21. Accordingly, the showerhead mount 21 is mounted to the sidewall of the water flow divider 11 at a position opposed to the switch thereof. In other words, the switch is positioned at one side of the water flow divider 11 while the showerhead mount 21 is positioned at an opposed side of the water flow divider 11. The second screw 22 is extended through the screw ring 14, the rotatable base 15, gasket 16 and the toothed gear 17 to rotatably couple with a screw hole of the showerhead mount 21, so as to securely mount the screw ring 14, the rotatable base 15, gasket 16 and the toothed gear 17 to the showerhead mount 21. The toothed gear 17 is received in the showerhead mount 21 at a position that a teething edge of the toothed gear 17 is engaged with an inner wall of the showerhead mount 21. The toothed gear 17 is coaxially mounted to the rotatable base 15 at an axle thereof, such that the toothed gear 17 is rotatably mounted to the rotatable base 15. The rotatable base 15 has two screw holes for the first screws 12 coupling thereto respectively. The two first screws 12 are extended through two mounting holes formed a sidewall of the water flow divider 11 to couple with the rotatable base 15, so as to mount the water flow divider 11 to the rotatable base 15.

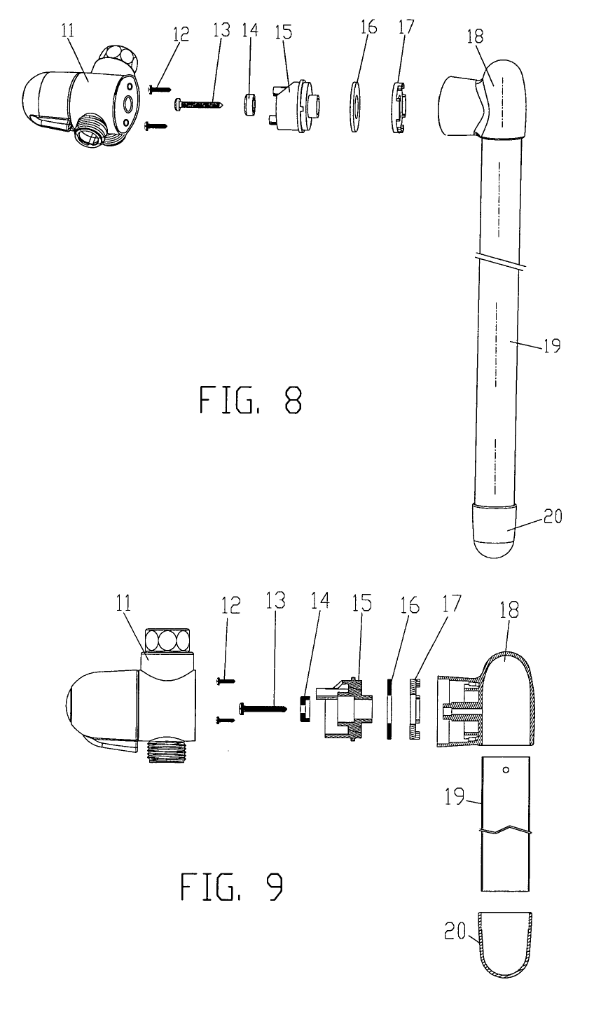

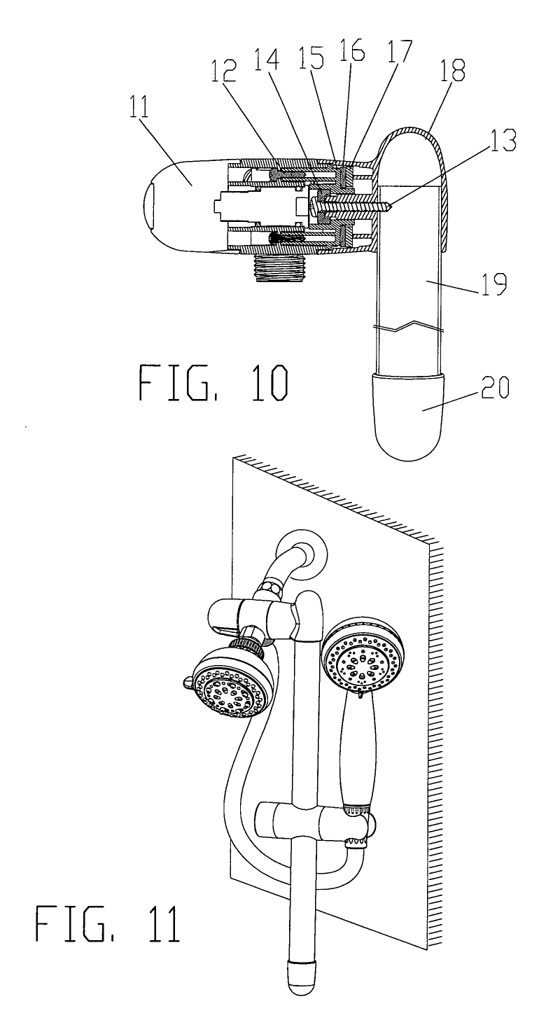

As shown in FIGS. 8, 9, and 10, the flow way diverter device comprises the water flow divider 11, two first screws 12, a second screw 13 having a size larger than a size of each of the first screws 12, a screw ring 14 for the second screw 22, a rotatable base 15, a gasket 16, a toothed gear 17, a supporting frame 18, an adjustable arm 19, and a covering cap 20. Accordingly, the switch is positioned at one side of the water flow divider 11 while the supporting frame 18 is positioned at an opposed side of the water flow divider 11. The second screw 13 is extended through the screw ring 14, the rotatable base 15, gasket 16 and the toothed gear 17 to rotatably couple with a screw hole of the supporting frame 18, so as to securely mount the screw ring 14, the rotatable base 15, gasket 16 and the toothed gear 17 to the supporting frame 18. The toothed gear 17 is received in the supporting frame 18 at a position that teething edge of the toothed gear 17 is engaged with an inner wall of the supporting frame 18. The toothed gear 17 is coaxially mounted to the rotatable base 15 at an axle thereof, such that the toothed gear 17 is rotatably mounted to the rotatable base 15. The rotatable base 15 has two screw holes for the first screws 12 coupling thereto respectively. The two first screws 12 are extended through two mounting holes formed a sidewall of the water flow divider 11 to couple with the rotatable base 15, so as to mount the water flow divider 11 to the rotatable base 15. The adjustable arm 19 has an upper end immovably affixed to the supporting frame 18 and a lower end affixed to the covering cap 20 to limit a sliding movement of the mount between the upper and lower ends of the adjustable arm 19. Therefore, the adjustable arm 19 is adapted to rotatably move with respect to the rotatable base 15 via the supporting frame 18, as shown in FIG. 7, in such a manner that a handheld showerhead mount is slidably mounted to the handheld showerhead to detachably mount the handheld showerhead so as to selectively adjust the position of the handheld showerhead along the adjustable arm 19.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims. For example, a water filter can be built-in with the water flow divider or externally mounted to the water flow divider to filter the water from the water inlet to at least one of the first and second outlets. Likewise, the modification for the present invention can be made that the switch can be actuated for switching water flowing from the water inlet to both the first and second outlets such that the stationary showerhead and the handheld showerhead can be supported at different heights for spraying the water towards the user at different body portions at the same time.

What is claimed is:

1. A flow way diverter device, comprising:
a water flow divider which has a water inlet for communicatively coupling with a water source on a wall, and first and second outlets for operatively coupling with a stationary showerhead and a handheld showerhead respectively, and comprises a switch selectively switching water flowing from said water inlet to one of said first and second outlets;
a supporting frame rotatably coupling with said water flow divider; and
an adjustable arm coupling with said supporting frame and a mount coupling with said adjustable arm, wherein said handheld showerhead is detachably mounted at said adjustable arm; such that said stationary showerhead and said handheld showerhead are connected to said water source and are supported on the wall without pre-drilling a mounting hole on the wall.

2. The flow way diverter device, as recited in claim 1, wherein said mount is slidably mounted along said adjustable arm such that when said handheld showerhead is detachably mounted at said adjustable arm, said handheld showerhead is selectively adjusted a height-position thereof with respect to said water flow divider.

3. The flow way diverter device, as recited in claim 1, wherein said adjustable arm is immovably affixed to said supporting frame such that when said supporting frame is rotated with respect to said water flow divider, said adjustable arm is driven to move for selectively adjusting an inclined position of said handheld showerhead with respect to said water flow divider.

4. The flow way diverter device, as recited in claim 2, wherein said adjustable arm is immovably affixed to said supporting frame such that when said supporting frame is rotated with respect to said water flow divider, said adjustable arm is driven to move for selectively adjusting an inclined position of said handheld showerhead with respect to said water flow divider.

5. The flow way diverter device, as recited in claim 2, further comprising a covering cap, wherein said adjustable arm has an upper end affixed to said supporting frame and a lower end mounted to said covering cap to limit a sliding movement of said mount between said upper and lower ends of said adjustable arm.

6. The flow way diverter device, as recited in claim 4, further comprising a covering cap, wherein said adjustable arm has an upper end affixed to said supporting frame and a lower end mounted to said covering cap to limit a sliding movement of said mount between said upper and lower ends of said adjustable arm.

7. The flow way diverter device, as recited in claim 1, wherein said switch is positioned at one side of said water flow divider while said supporting frame is positioned at an opposed side of said water flow divider.

8. The flow way diverter device, as recited in claim 4, wherein said switch is positioned at one side of said water flow divider while said supporting frame is positioned at an opposed side of said water flow divider.

9. The flow way diverter device, as recited in claim 6, wherein said switch is positioned at one side of said water flow divider while said supporting frame is positioned at an opposed side of said water flow divider.

10. The flow way diverter device, as recited in claim 1, wherein said supporting frame rotatably coupling with said water flow divider via a rotatable joint which comprises a rotatable base and a toothed gear coaxially mounted to said rotatable base at an axle thereof, such that said toothed gear is rotatably mounted to said rotatable base to rotatably mount said supporting frame to said water flow divider.

11. The flow way diverter device, as recited in claim 4, wherein said supporting frame rotatably coupling with said water flow divider via a rotatable joint which comprises a rotatable base and a toothed gear coaxially mounted to said rotatable base at an axle thereof, such that said toothed gear is rotatably mounted to said rotatable base to rotatably mount said supporting frame to said water flow divider.

12. The flow way diverter device, as recited in claim 9, wherein said supporting frame rotatably coupling with said water flow divider via a rotatable joint which comprises a rotatable base and a toothed gear coaxially mounted to said rotatable base at an axle thereof, such that said toothed gear is rotatably mounted to said rotatable base to rotatably mount said supporting frame to said water flow divider.

13. The flow way diverter device, as recited in claim 10, wherein said toothed gear is received in said supporting frame at a position that a teething edge of said toothed gear is engaged with an inner wall of said supporting frame.

14. The flow way diverter device, as recited in claim 11, wherein said toothed gear is received in said supporting frame at a position that a teething edge of said toothed gear is engaged with an inner wall of said supporting frame.

15. The flow way diverter device, as recited in claim 12, wherein said toothed gear is received in said supporting frame at a position that a teething edge of said toothed gear is engaged with an inner wall of said supporting frame.

16. A flow way diverter device, comprising:
a water flow divider which has a water inlet for communicatively coupling with a water source on a wall, and first and second outlets for operatively coupling with a stationary showerhead and a hand showerhead respectively, and comprises a switch selectively switching water flowing from said water inlet to one of said first and second outlets;
a supporting frame, which is rotatably coupling with said water flow divider, comprising a showerhead mount rotatably mounted on a sidewall of said water flow divider, wherein said handheld showerhead is detachably mounted at said showerhead mount and is selectively adjusted an inclined position thereof with respect to said water flow divider, such that said stationary showerhead and said handheld showerhead are connected to said water source and are supported on the wall without pre-drilling a mounting hole on the wall.

17. The flow way diverter device, as recited in claim 16, wherein said switch is positioned at one side of said water flow divider while said supporting frame is positioned at an opposed side of said water flow divider.

18. The flow way diverter device, as recited in claim 16, wherein said supporting frame rotatably coupling with said water flow divider via a rotatable joint which comprises a rotatable base and a toothed gear coaxially mounted to said rotatable base at an axle thereof, such that said toothed gear is rotatably mounted to said rotatable base to rotatably mount said supporting frame to said water flow divider.

19. The flow way diverter device, as recited in claim 17, wherein said supporting frame rotatably coupling with said water flow divider via a rotatable joint which comprises a rotatable base and a toothed gear coaxially mounted to said rotatable base at an axle thereof, such that said toothed gear is rotatably mounted to said rotatable base to rotatably mount said supporting frame to said water flow divider.

20. The flow way diverter device, as recited in claim 19, wherein said toothed gear is received in said showerhead mount of said supporting frame at a position that a teething edge of said toothed gear is engaged with an inner wall of said showerhead mount.
